(19) United States
(12) Patent Application Publication
(10) Pub. No.: US 2008/0173667 A1
(43) Pub. Date: Jul. 24, 2008

(54) DISPENSING OF LIQUID WITH ARRAYS OF TUBULAR QUILL STRUCTURES

(75) Inventors: Jurgen H. Daniel, San Francisco, CA (US); Barkev Keoshkerian, Thornhill (CA); Naveen Chopra, Oakville (CA); Peter M. Kazmaier, Mississauga (CA)

Correspondence Address: MARGER JOHNSON & MCCOLLOM/PARC, 210 MORRISON STREET, SUITE 400, PORTLAND, OR, 97204, US

(73) Assignees: PALO ALTO RESEARCH CENTER INCORPORATED, Palo Alto, CA (US); XEROX CORPORATION, Stamford, CT (US)

(21) Appl. No.: 11/625,166

(22) Filed: Jan. 19, 2007

(51) Int. Cl. G01F 11/00

(52) U.S. Cl. 222/1

(57) ABSTRACT

A method of dispensing display fluid into an array of cells loads an array of quills with the fluid. inserts the array of quills loaded with the fluid into the array of cells, such that each quill is inserted into a separate cell, contacts an inner surface of the cells to cause the fluid to transfer from the quills to the cells, and seals the cells. A dispensing system has a first substrate having an array of quills arranged on a first pitch, a first fixture to hold the first substrate, a second substrate having an array of cells, wherein the cells are arranged on a second pitch that is proportional to the first pitch, a second fixture to hold the second substrate, and an alignment system to align the first substrate to the second substrate such that each quill dispenses a display fluid into selected ones of the cells. An array of quills reside on a substrate, the quills having a lateral extent less than a lateral dimension of a cell into which the quills will be inserted, and a vertical extent at least twice the vertical extent of a depth of the cells.

### BACKGROUND

Electrophoretic displays consist of microcapsules or cell structures. In some displays, the manufacturing process fabricates the cells using photolithography or molding. The process puts ink into the cells by doctor blading the ink into the cells. In the case of electrophoretic displays, the doctor blade pushes the ink into the cells and at the same time cleans off any excess of ink. The process then seals the cells to contain the ink by applying a sealing polymer, etc.

For color displays, each picture element (pixel) must be divided into several sub-pixels, each for a different color. In the case of electrophoretic displays, the manufacturing process must deposit different colored inks into each sub-pixel. Doctor-blading will not work in this type of system.

Possible methods to fill the cells with different color inks include ink jet printing. However, the inks used in electrophoretic displays have high particle loading making them hard to jet. A dip-pen or quill-type dispensing method may provide some other possibilities.

### SUMMARY

An embodiment is method of dispensing display fluid into an array of cells that loads an array of quills with the fluid, inserts the array of quills loaded with the fluid into the array of cells, such that each quill is inserted into a separate cell, contacts an inner surface of the cells to cause the fluid to transfer from the quills to the cells, and seals the cells.

Another embodiment is a dispensing system that has a first substrate having an array of quills arranged on a first pitch, a first fixture to hold the first substrate, a second substrate having an array of cells, wherein the cells are arranged on a second pitch that is proportional to the first pitch, a second fixture to hold the second substrate, and an alignment system to align the first substrate to the second substrate such that each quill dispenses a display fluid into selected ones of the cells.

Another embodiment is an array of quills that reside on a substrate, the quills having a lateral extent less than a lateral dimension of a cell into which the quills will be inserted, and a vertical extent at least twice the vertical extent of a depth of the cells.

### BRIEF DESCRIPTION OF THE DRAWINGS

Embodiments of the invention may be best understood by reading the disclosure with reference to the drawings, wherein:

FIGS. 1-5 show an example of a method of collecting and dispensing a liquid using quill structures.

FIG. 6 shows a perspective view of an example of a substrate having quill micro structures.

FIG. 7 shows an alternative example of a quill microstructure.

FIG. 8 shows an example of a quill microstructure in the loaded state.

FIGS. 9 and 10 show side and top view of alternative architectures of the quills.

FIG. 11 shows an example of a spring quill microstructure.

FIG. 12 shows side views of alternative examples of compliant quill microstructures.

FIGS. 13-15 show an example of a method of multiple dispensing of ink.

FIGS. 16-18 show alternative examples of architectures for multiple dispensing of liquid.

FIG. 19 shows an example of a color display panel with corresponding examples of quill microstructure substrates for the colors.

FIGS. 20-21 show examples of systems for dispensing liquid.

### DETAILED DESCRIPTION OF THE EMBODIMENTS

Electrophoretic displays form images by control of electrophoretic motion of charged, colored pigmented particles. These particles move when under the influence of an electric field, and manipulation and control of the fields cause the particles to move in such a manner as to determine the color of a pixel (picture element). Electrophoretic displays generally have panels made up of an array of cells, each cell corresponding to a pixel or portion of a pixel in the rendered image. Cell, as used here, means a structure that can contain a fluid. Specifically to the application of the electrophoretic display, the cell may also include an addressing means to allow control of the electric field with regard to that fluid. Electrophoretic displays are an example of a display that uses a ‘display fluid’ that is a fluid containing particles that may be influenced by an electric field, generally contained in individual cells.

Dispensing of the colored particles into the cell array such that the correct cells contain the correct colors gives rise to some difficulties. Typical methods of applying liquids to a surface, such as doctor blading, cannot be used with sufficient precision. Generally, the colored liquids, referred to here as inks, contain the particles that allow electrophoresis to occur. The high particle loading required for good contrast displays makes ink-jetting the liquid into the cells rather challenging. Other dispensing methods may exist.

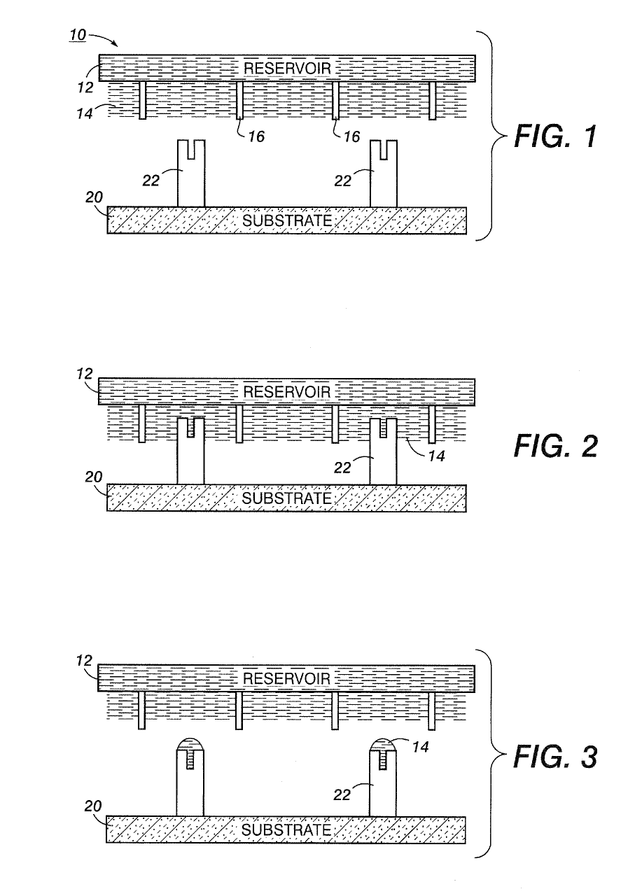

FIGS. 1-5 show one method of dispensing ink or liquids into an array of cells. In FIG. 1, the dispensing system 10 has an ink reservoir 12, which may or not include partitions such as 16 to contain the liquid, in this case ink 14. Ink means the liquid that contains the charged, color particles that provide the color to the electrophoretic display and can be moved using electric fields.

An array of quill microstructures such as 22 resides on a substrate 20. A quill microstructure is a pillar, tubular or quill-like structure having a small size, on the order of 20-1000 micrometers (microns) high, and manufactured on a pitch from 50-2000 microns, as an example. The microstructure may have a small reservoir or region that contains a defined amount of ink and also may allow multiple dispensing of ink. The quill itself may also be referred to as a pillar. Generally, the quill will have at least a portion of its length that is ‘hollow’ to allow it to pick up and temporarily store ink. In the state where the quill is holding ink, it may be referred to as being in a ‘loaded’ state. The process of transferring ink into the quill may be referred to as ‘loading.’

Dispensing of biological fluids has been accomplished using dip-pen or quill structures, such as is disclosed in U.S. Pat. No. 6,722,395. These techniques are generally done using single quills or macroscopic pin arrays and onto substrates that are not divided into cells. While the amount of liquid may be very precise, the placement is generally not. In contrast, dispensing from an array of finely spaced quills into a set of fixed positions as in dispensing into an array of fine-pitch cells has an entirely different set of challenges of alignment and precision.

In FIG. 1, the substrate 20 having the quill microstructures is aligned adjacent to an ink reservoir 12. It should be noted that it may be advantageous to agitate the reservoir 12, such as by ultrasonic agitation. This would keep the electrophoretic particles well suspended and would reduce concerns of particle settling. For a display with good uniformity it is important to fill the cells with ink that contains similar quantities of particles for each cell. Particle settling in the reservoir would compromise this uniformity requirement. In one example, ultrasonic agitation is achieved by attaching an ultrasonic actuator such as a vibrating piezo actuator to the substrate of the reservoir 12. The agitation may be briefly interrupted during the inking step of the quills.

In FIG. 2, the substrate 20 moves closer to the ink reservoir such that the quill microstructures dip into the ink 14. The surface tension of the ink together with the surface energy of the quill surface causes some portion of it to transfer to the quill 22 by capillary force. In FIG. 3, the substrate 20 moves away from the ink reservoir, and one can see that the quills are loaded with ink 14. The ink reservoir could also be similar to a sponge as the ones used in stamping. When the quills touch the sponge, ink is transferred.

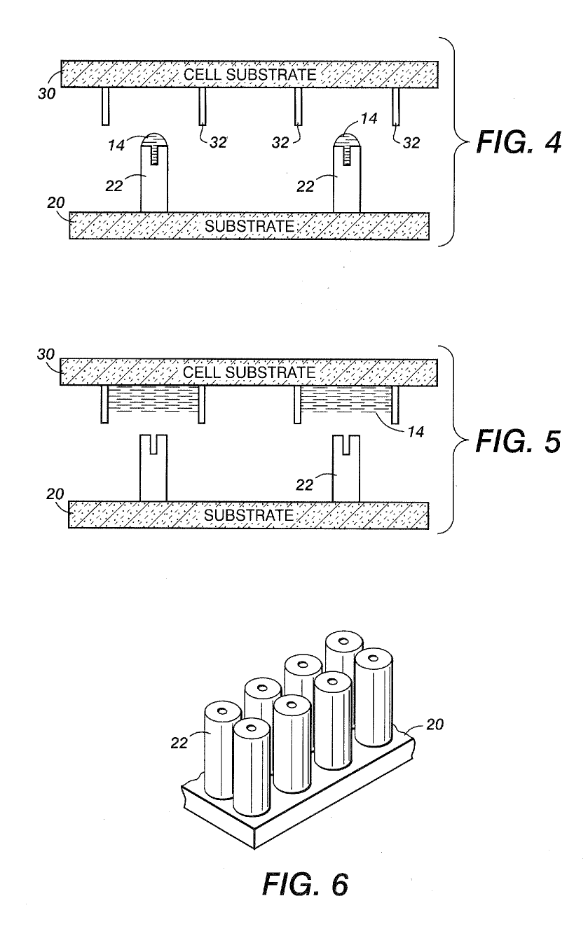

In FIG. 4, the substrate having the quill microstructures lines up over the cell substrate of the electrophoretic display cell substrate 30, which may also be referred to as a display panel. The loaded quills, such as 22, have ink 14. The cell substrate 30 has partitions or other barriers such as 32 between the cells and the substrate 20 must align such that the quills line up between the barriers 32. When the substrate 20 moves next to the cell substrate such that the quills or the ink surrounding the quills touch an inner surface of the cells defined by the barriers such as 32, the ink 14 transfers into the cells, as can be seen in FIG. 5. The transfer of ink may occur when the quills touch the ‘bottom’ surface of the cells, or one of the sides. In either case, the quills or the ink on the quills make contact with a surface on the inside of the cells, referred to here as an inner surface. Usually, not all of the ink will be transferred and the transferred amount depends upon the surface properties of the cells and the pin and the capillary forces acting on the fluid from both sides.

After the quills have dispensed their liquid or ink, the cells are generally sealed. Sealing may involve placing a layer of polymer or other substance over the surface of the cells to seal the ink. One example of placing a layer of polymer or other substance over the cells to seal the ink is given in US Patent Application Publication No. 20060132579, commonly assigned with this application and incorporated by reference herein in its entirety. Alternatively, a sealing polymer solution may already reside in the cells, accepting and ‘sealing’ the ink after the solvent of the solution has evaporated. An example of such a material is a Cytop® fluorocarbon solution, a material manufactured by Asahi Glass, which acts as an encapsulating polymer by surrounding the ink. An example of this process is given in US Patent Application Publication No. 20050285921, commonly assigned with this application and incorporated by reference herein in its entirety.

In one example, quills have a pipette type structure of a hollow tube, as shown in FIG. 6. The substrate 20 has formed upon it an array of quills 22. The quills load the ink into at least part of their interior pipes when they come into contact with the ink, such as in the ink reservoir as shown in FIG. 1. The loading is driven by capillary forces and if the inner tube is closed off at the bottom, the ink is accepted until the capillary force and the counter force due to the compresses air in bottom of the tube are equal. It should be mentioned that the capillary force driving the liquid into the tube should not be too high, otherwise it will be difficult to transfer the liquid later on to the cells. In order to transfer the fluid a counter force has to pull liquid out of the tube structure.

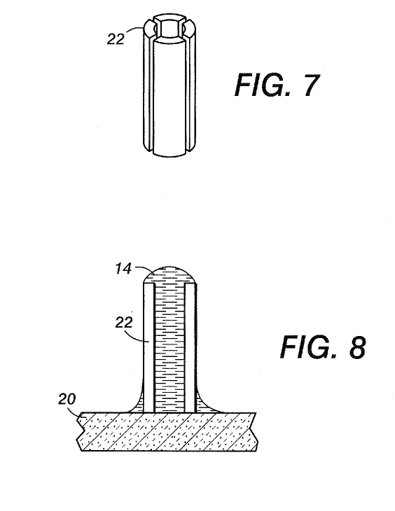

As will be discussed in more detail further, the pipettes may have many different structures. FIG. 7 shows an alternative structure where the pipette structure has four segments, with gaps between the segments. This may allow the quill to store a larger quantity of ink, such that it may be used for multiple dispensings of ink for one loading. If the gap extends to the substrate it becomes possible to load the quills from the bottom near the substrate with ink.

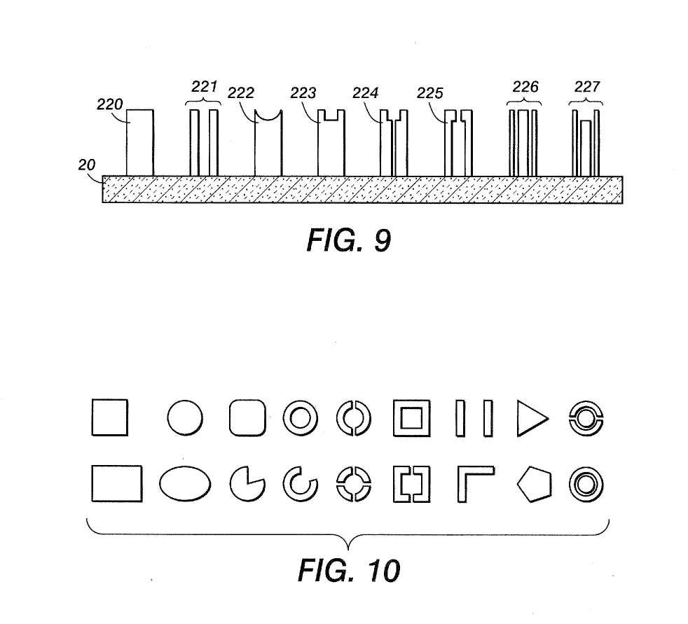

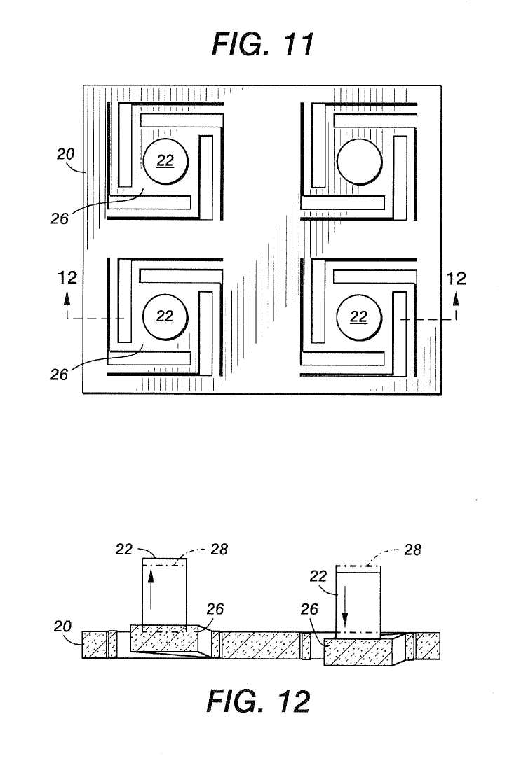

As shown in FIG. 8, the quill 22 ‘stores’ extra ink 14 around its base, the ink remaining there due to the ink having high surface tension. An advantage of this may result from the ability to perform more than one dispensing from one loading process, as will be discussed in more detail later. Variations on the structures of the quills may allow different advantages for different applications. FIGS. 9 and 10 show side and top views of other quill architectures. In one example a 100 microns by 100 microns wide and 30 microns high cell required an ink volume of ˜0.3 nL in order to be completely filled. Usually the cells would be slightly underfilled in order to leave space for the sealing layer.

FIG. 9 shows a side view of many variations of the quill structure. From left to right as shown in the figure, the quills may take the form of a solid pillar as in 220, a structure with a tube or pipe 221, a structure with a concave top 222, a square or rectangular structure with a notch 223, a combination of a structure with a notch and a tube 224, an alternative combination of a notch and a tube 225, multiple tubes 226, a combination of a notch and multiple tubes 227, etc. FIG. 10 shows variations on the top views of the quills as well, showing round, square, rectangular, oval, hollow, split, triangular, pentagonal, l-shaped, round with a notch, multiple tubes, etc. The quills may also be tapered meaning their diameter may be larger or smaller near the substrate as compared to the diameter at the opposite quill end.

As noted above, the quill may be manufactured out of polymers, such as the photoresist SU-8 (MicroChem Corp.), metal, a combination of metal and polymers, a combination of hard and soft polymers such as an SU-8 epoxy base with a compliant silicone top. Another example of soft or elastomeric polymers would include polyurethanes or silicone gels.

The definition of hard and soft polymers may be roughly defined by their Tg (glass transition temperature). Below the Tg, polymers are in a glassy state, and above the Tg, they are in a rubbery state. In general, the greater the Tg, the harder the polymer. Examples of hard polymers include polymethylmethacrylate (PMMA) or polystyrene, which are glassy at room temperature and both having a Tg of approx. 100° C. Examples of soft polymers include polydimethylsiloxane (PDMS) and polyethylene, with Tg's of approx. −125° C. and −80° C., respectively.

The quills also may have a coating to adjust the surface energy, such as a silane coating, a plasma polymer coating, plasma surface conditioning or a solution coated polymer coating. Amongst low surface energy coatings are fluorsilanes, long-chain alkylsilanes, plasma treatments with a fluorinated plasma such as CF4 (carbon tetrafluoride), vapor deposited parylene or solution deposited fluoropolymers such as Cytop® (Asahi Glass), for example. A surface with a higher surface energy (more hydrophilic) may be achieved by an oxygen plasma treatment, by depositing more polar silanes such as PEG (polyethylene-glycol)-silanes or by depositing polymer layers such as PVA (polyvinyl alcohol) or PVP (polyvinylpyrrolidone), for example. This may facilitate liquid transfer.

The surface roughness of the pillars can also play a significant role in the liquid transfer, because it can enhance the hydrophobic or hydrophilic properties of the pillars. The roughness may be adjusted by etching, such as roughening by plasma etching in an oxygen plasma in the case of polymer pillars, or by depositing a material such as a sputter deposited metal film with large-grain size, for example.

The quills will typically have a lateral extent that is less than the lateral extent of the cells into which the quills are inserted. In one example, the quills have a vertical extent that is twice the depth of the cells. Since the quills may touch inside the cells of the cell substrate 30, some provision for compliance across the array of quills may assist in ensuring that all quills touch and that no quills touch down hard enough to damage the cell.

FIG. 11 shows one example of a compliant quill structure where the quill structure 22 has a spring foundation 26 that allows the quills to move and flex up and down as needed to ensure contact and thus liquid transfer. Examples of single spring structures are manufactured by Parallel Synthesis, (www.parallel-synthesis.com).

FIG. 12 shows a side view. In FIG. 12, some of the pillars 22 reside on springs 26. In the alternative, an elastic polymer coating 28 may allow the tip of the quills to be made more compliant. The selection of a particular form of compliance, as well as the selection of the quill structure depends upon the nature of the liquid dispensed and the manufacturing constraints in the process such as the cell pitch, etc. For example, using a tube structure may allow the use of a local reservoir of ink.

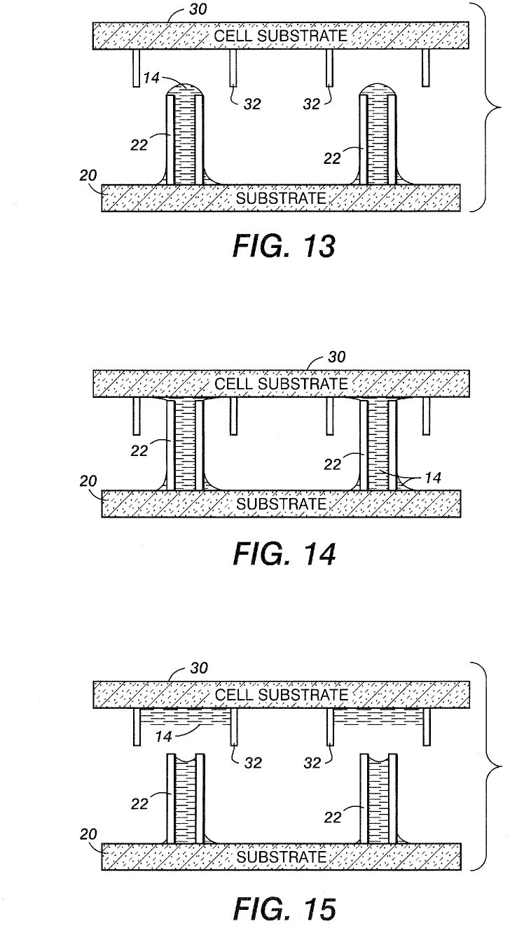

FIGS. 13-15 show an example of a process in which multiple dispenses occur from one ink load. In FIG. 13, loaded quills such as 22 have a quantity of ink 14 around their bases. The quills transfer a portion of that quantity of ink 14 in FIG. 14 by contacting the bottom surface of the cells on substrate 30. In FIG. 15, one can see that the cells on the substrate 30 have received ink, and some smaller quantity of ink 14 remains around the base of the quill 22 to be used in another dispensing process. The ability to dispense ink multiple times from one loading cycle may simplify some dispensing processes.

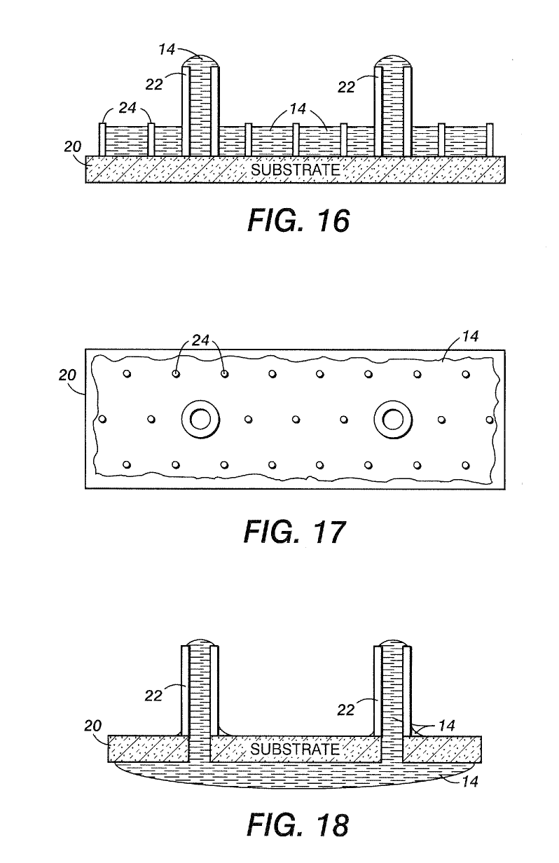

FIGS. 16-18 show other examples of the quill and dispensing substrates that may allow multiple dispensings from one ink load. In FIG. 16, quills 22 are surrounded by smaller quills 24 on the substrate 20. The quills 24 facilitate retention of the ink 14, giving the ink a structure to which it can ‘cling,’ until drawn into the quills. The surface energy of the surfaces as well as the spacing of the quills 24 has to be chosen carefully so that the ink is not held too strongly in between the quills. The capillary forces when transferring fluid through the quill pillar have to be strong enough to pull ink out of the reservoir structure. FIG. 17 shows a top view.

As an alternative, FIG. 18 shows a quill structure that draws ink from a side of the substrate opposite from the quills. The ink 14 resides on the other side of the substrate 20 until drawn into the quill 22. The substrate 20 would use a through hole to allow the ink to pass from one side to the other. The through hole could be fabricated by laser etching, e.g. into a stainless steel plate or anisotropic reactive ion etching of a silicon substrate. For color dispensing, only one color of ink would typically be used for each substrate 20, with multiple dispensing arrays.

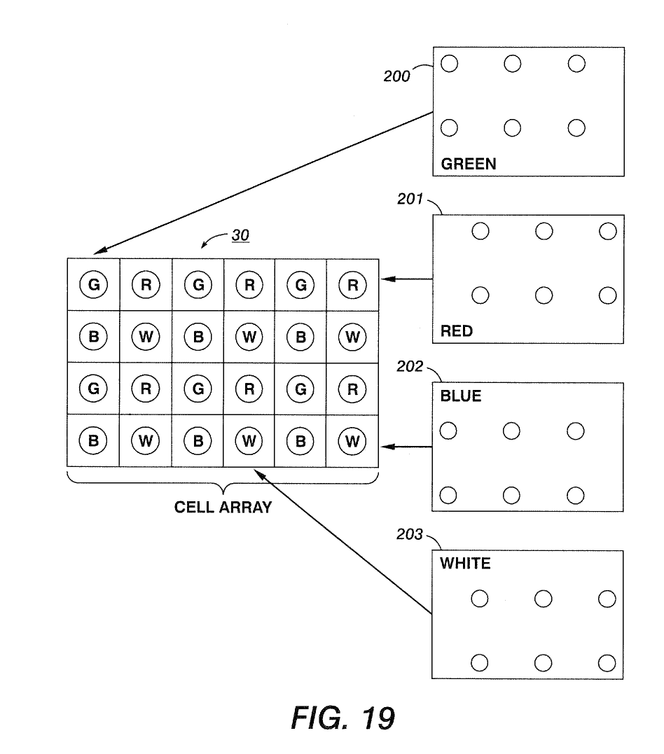

In FIGS. 1-5 and 13-15, one may note that a one-to-one correspondence between the quills on substrate 20 and the cells on the display substrate 30 does not exist. In many implementations of color displays, one pixel may actually have several sub pixels, each of a different color. In one example, the colors are red, green, blue and white. In many displays, white results from mixing the other three colors together, or allowing a back light to show through unaltered. In most electrophoretic displays, the displays use the panels as reflectors. In order to have a white pixel, or even to ‘lighten up’ colored pixels, a white cell must provide the white color. FIG. 19 shows an example of this type of panel.

The cell substrate 30 has four sub-pixels for each pixel of the displayed image. The sub-pixels are green, red, blue and white. As shown here the sub-pixels fall in groups. Many other groupings are possible, including lines of a particular color, diagonals, hexagonal configurations, etc. The dispensing arrays have a pitch that has a proportional relationship to the cell array. In this example, the relationship is that the dispensing quills have twice the pitch of the cell array, and are offset depending upon the color.

As can be seen by the green dispensing array 200, the green dispensing quills align with the left, upper corner of the cell substrate 30. The red dispensing array 201 is offset one to the right from the upper left corner. The blue dispensing array 202 is offset one down from the upper left corner. The white dispensing an-ay 203 is offset one to the right and one down from the upper left corner. Again, as noted above, the pitch of the dispensing arrays maybe altered to match particular configurations of color patterns.

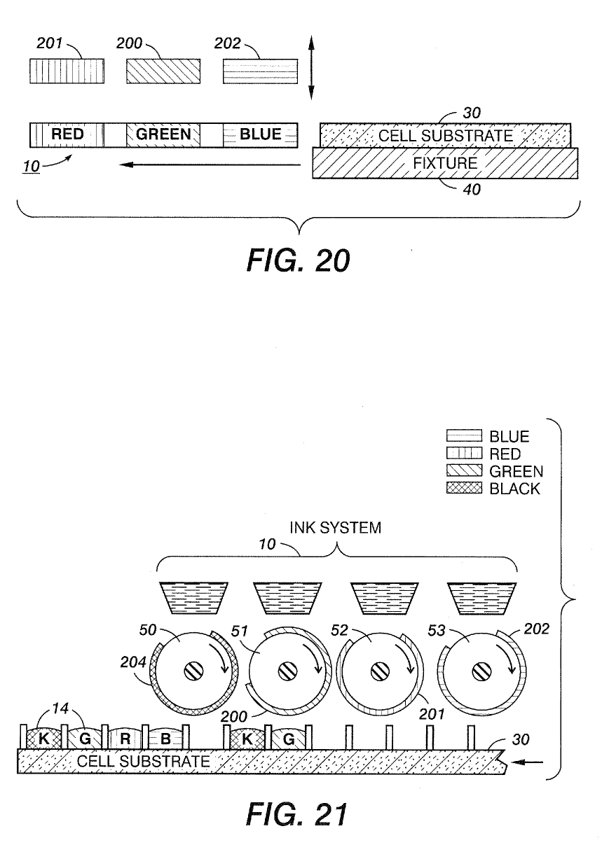

Each of the dispensing arrays would have to acquire ink and then be inserted into the cells to transfer the ink to the cells in such a manner as to remain properly aligned. FIGS. 20 and 21 show examples of such a dispensing system.

In FIG. 20, a linear approach has an ink reservoir 10 that has ink reservoirs for each of the colors. In the example for simplicity only red, green and blue are shown. The red, green and blue dispensing arrays 201, 200 and 202 are actuated vertically to lower into the ink reservoirs and load the quills with ink. In the same manner the ink reservoirs may also be raised in order to ink the quills. A fixture 40, such as an X-Y stage, travels as shown to move the cell substrate 30 under the dispensing arrays in turn. An alignment system would manipulate the fixture 40 to ensure that the alignment stayed true throughout the dispensing process. Similarly, instead of moving the substrate 30 with a fixture, the substrate may remain stationary and the dispensing arrays 201, 200 and 202 may be attached to a fixture that moves them into position. A vertical actuator such as a linear Z-stage would move each array sequentially towards the substrate. The linear stages may be for example ball-screw stages as for example from Aerotech Corporation or air bearing stages. For precise positioning, stage movement may be based on piezo actuation.

As an alternative, the dispensing arrays could reside on a drum such as shown in FIG. 21. In this example, the fixture 50 is a drum to which are mounted the dispensing arrays 200, 201 and 202. Shown here is a black dispensing array 204, which, in the case of electrophoretic displays, may consist of black and white electrophoretic particles and provide the color states white and black. As the drums 50, 51, 52 and 53 spin, the quills such as 22 receive ink from the inking system or reservoir 10. The cell substrate 30 moves under the drums as the quills align with the cells and dispense their liquids into the cells. This approach is referred to as a roll-to-roll system, as opposed to the linear or linear stage system of FIG. 20. Having several drums in series which each drum dispensing only one color may be preferred over having one drum with dispensing quills for each color. This approach is similar to a color printing system.

In this manner, the cells of an electrophoretic display panel may receive the appropriate color of ink. While the embodiments discussed here use the electrophoretic display as an example, the methods discussed here may be suitable for any type of dispensing system in which the system dispenses different liquids into neighboring cells on a relatively small pitch.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of dispensing display fluid into an array of cells, comprising:
loading an array of quills with the fluid;
inserting the array of quills loaded with the fluid into the array of cells, such that each quill is inserted into a separate cell;
contacting an inner surface of the cells to cause the fluid to transfer from the quills to the cells; and
sealing the cells.

2. The method of claim 1, wherein contacting an inner surface of the cells comprises contacting a side surface of the cells.

3. The method of claim 1, wherein contacting an inner surface of the cells comprises contacting a bottom surface of the cells.

4. The method of claim 1, wherein sealing the cells comprises applying a liquid sealing polymer over the cells and curing the polymer.

5. The method of claim 1, wherein sealing the cells comprises transferring the fluid into a sealing polymer solution.

6. The method of claim 1, wherein the fluid comprises electrophoretic inks and the cells comprise cells of an electrophoretic display panel.

7. A dispensing system, comprising:
a first substrate having an array of quills arranged on a first pitch;
a first fixture to hold the first substrate;
a second substrate having an array of cells, wherein the cells are arranged on a second pitch that is proportional to the first pitch;
a second fixture to hold the second substrate; and
an alignment system to align the first substrate to the second substrate such that each quill dispenses a display fluid into selected ones of the cells.

8. The dispensing system of claim 7, wherein each quill having a lateral extent smaller than a lateral extent of cells to be filled by the quills and a vertical extent at least twice a depth of the cells.

9. The dispensing system of claim 7, wherein each quill comprises one of polymer, metal, a combination of polymer and metal, or a combination of a hard polymer and a soft polymer.

10. The dispensing system of claim 7, wherein each quill has a coating of one of either an elastomer or a material to adjust the surface energy of the pillar.

11. The dispensing system of claim 7, wherein each quill has at least one of a tubular, square, triangular, slit, l-shaped, oval, hexagonal, pentagonal, notched or octagonal shape.

12. The dispensing system of claim 7, wherein the first substrate further comprises several substrates of quills, each for a different color display fluid.

13. The dispensing system of claim 7, wherein the first and second fixtures are drums.

14. The dispensing system of claim 7, wherein the first pitch is arranged in a geometry to form an ink pattern on the second substrate, wherein the ink pattern is one of square, linear, diagonal or hexagonal.

15. An array of quills, comprising:
an array of quills on a substrate having a lateral extent less than a lateral dimension of a cell into which the quills will be inserted, and a vertical extent at least twice the vertical extent of a depth of the cells.

16. The array of quills of claim 15, wherein the array of quills comprises one of polymer, metal, a combination of polymer and metal, or a combination of a hard polymer and a soft polymer.

17. The array of quills of claim 15, wherein each quill has a coating of one of either an elastomer or a material to adjust the surface energy of the pillar.

18. The array of quills of claim 15, wherein each quill has one of a tubular, square, triangular, slit, l-shaped, oval, hexagonal, pentagonal or octagonal shape.

19. The array of quills of claim 15, wherein a pitch of the quills is twice a pitch of the cells.

20. The array of quills of claim 15, each quill being mounted on a spring.

21. The array of quills of claim 15, each quill arranged to store a local reservoir of fluid.

22. The array of quills of claim 15, wherein the substrate has pillars dispersed among the quills to retain fluid on the substrate to feed the quills.

23. The array of quills of claim 15, wherein the substrate has through holes at a base of each quill to allow passage of ink from a reservoir of fluid on a opposite side of the substrate from the quills.
